(19) United States
(12) Patent Application Publication
(10) Pub. No.: US 2009/0307049 A1
(43) Pub. Date: Dec. 10, 2009

(54) Soft Co-Clustering of Data

(75) Inventors: Frank W. Elliott, JR., San Diego, CA (US); Richard Rohwer, San Diego, CA (US); Stephen C. Jones, Oceanside, CA (US); George J. Tucker, Cambridge, MA (US); Christopher J. Kain, Bremerton, WA (US); Craig N. Weidert, Vancouver (CA)

Correspondence Address: FISH & RICHARDSON P.C., PO BOX 1022, MINNEAPOLIS, MN, 55440-1022, US

(73) Assignee: Fair Isaac Corporation

(21) Appl. No.: 12/133,902

(22) Filed: Jun. 5, 2008

(51) Int. Cl. G06Q 10/00; G06Q 30/00

(52) U.S. Cl. 705/10; 705/7

(57) ABSTRACT

The subject matter of this specification can be embodied in, among other things, a method that includes accessing a data structure that includes information about purchasers, merchants, and financial transactions between the purchasers and the merchants and generating purchaser clusters. Generating purchaser clusters includes clustering the purchasers based on which purchasers make purchases from the same or similar merchants. Each purchaser cluster adopts associations between purchasers belonging to the purchase cluster and merchants from which these purchasers have made purchases. The method also includes generating merchant clusters, where generating the merchant clusters includes clustering merchants based on which merchants are associated with the same or similar purchase clusters and outputting profile information that characterizes typical purchases associated with one or more of the merchant clusters for use in detecting fraudulent transactions.

### TECHNICAL FIELD

This instant specification relates to clustering data sets.

### BACKGROUND

One of the largest areas of retail loss is in the fraudulent use of bank and credit cards in online transactions. Some current fraud detection systems attempt to identify fraudulent transactions by using predictive models that identify a transaction as fraudulent based on predictive variables such as an average spending amount for a particular purchaser in a transaction. For example, if a purchaser rarely makes purchases of above $100, then a transaction associated with the purchaser for $800 may be indicative of fraud. The average, or typical, spending amount for the individual can be encoded in the predictive variables used by the fraud detection system.

### SUMMARY

In general, this document describes a probabilistic method for computing indirect relationships between first data based on direct relationships between the first data and second data. For example, merchants can be clustered based on transactions with purchasers. Profiles can then be derived and associated with merchant clusters for use in detecting fraudulent transactions.

In a first general aspect, a computer-implemented method is described. The method includes accessing a data structure that includes information about purchasers, merchants, and financial transactions between the purchasers and the merchants and generating purchaser clusters. Generating purchaser clusters includes clustering the purchasers based on which purchasers make purchases from the same or similar merchants. Each purchaser cluster adopts associations between purchasers belonging to the purchase cluster and merchants from which these purchasers have made purchases.

The method also includes generating merchant clusters, where generating the merchant clusters includes clustering merchants based on which merchants are associated with the same or similar purchase clusters and outputting profile information that characterizes typical purchases associated with one or more of the merchant clusters for use in detecting fraudulent transactions.

In a second general aspect, a system is described. The system includes a data structure that, in turn, includes information about purchasers, merchants, and financial transactions between the purchasers and the merchants. The system also includes a purchaser clusterer to generate purchaser clusters including clustering the purchasers based on which purchasers make purchases from the same or similar merchants. Each purchaser cluster adopts associations between purchasers belonging to the purchase cluster and merchants from which these purchasers have made purchases. The system also includes a merchant clusterer to generate merchant clusters comprising clustering merchants based on which merchants are associated with the same or similar purchase clusters and an interface to output profile information that characterizes typical purchases associated with one or more of the merchant clusters for use in detecting fraudulent transactions.

The systems and techniques described here may provide one or more of the following advantages. First, merchants may be clustered based on how purchasers relate to merchants regardless of whether the system has any information about how the merchants related to each other. Additionally, the soft clustering of merchants patronized by a cardholder may enable cardholder spending to be characterized in a way that is both descriptive and statistically significant. By producing a time average in each merchant category, a model can create a detailed pattern of cardholder spending. Changes in this detailed pattern of spending can signal fraud.

The details of one or more embodiments are set forth in the accompanying drawings and the description below. Other features and advantages will be apparent from the description and drawings, and from the claims.

### DESCRIPTION OF DRAWINGS

FIG. 1 is a diagram of an example system for generating profile data associated with merchant clusters for use in detecting fraudulent transactions.

FIG. 2 is a diagram of an example clustering system for grouping merchants to derive profile variables associated with the grouped merchants.

FIGS. 3A and 3B are an example subject-verb-object-frequency (SVOF) graph and an adjacency matrix representation of the graph, respectively.

FIG. 3C is a table 340 that states example probabilities that each subject will be associated with each object.

FIGS. 4A and 4B are descriptions of an example Dirichlet Multinomial Mixture (DMM) model used to cluster purchasers.

FIG. 4C is a table including example results of a maximum likelihood estimation for parameters of a DMM model.

FIGS. 5A and 5B are descriptions of an example Dirichlet Mixture (DM) model used to cluster merchants.

FIG. 6 is an example general computer system.

Like reference symbols in the various drawings indicate like elements.

### DETAILED DESCRIPTION

This document describes systems and techniques for generating profile information associated with clusters of merchants, where the profile information can be used to detect possible fraudulent transactions based on deviations from, for example, spending averages associated with the clusters of merchants. For example, if a merchant belongs to a particular merchant clusters that has norm spending average of about $40.00 per transaction, a transaction with the merchant for $450.00 may indicate the transaction is fraudulent. Furthermore, spending associated with a particular merchant cluster relative to total spending can be monitored. For example, if spending in a particular merchant cluster suddenly becomes more prominent in comparison with total spending, this may be an indication of fraud.

In some implementations, a clustering system may generate merchant clusters by first grouping purchasers based on whether the purchasers have a similar frequency of transactions with a similar set of merchants. The clustering system may then use the groups of purchasers, or purchaser clusters, as a data source to create merchant clusters. For example, the clustering system can determine—for each purchase cluster—a probability that a transaction (e.g., between a merchant and purchaser) is associated with that purchaser cluster. The clustering system may then cluster merchants associated with the analyzed transactions based on whether the merchants' transactions have a similar distribution of probabilities.

In a simple illustrious example, a first merchant may have first and second transactions with probabilities 0.3 and 0.7, respectively, that the transactions are associated with a first purchase cluster. A second merchant may have third and fourth transactions with probabilities of 0.25 and 0.6, respectively. The clustering system may cluster the first and second merchant into a merchant cluster based on the similar distribution of probabilities that their transactions are associated with the first purchase cluster. If, on the other hand, the second merchant had a probability distribution of 0.9 and 0.45, the clustering system may have grouped the merchants in separate merchant clusters because of the dissimilarity in probability distribution.

In more complicated examples, the merchants may be associated with many transactions, which are in turn, associated with a multitude of purchaser clusters. Additionally, the clustering system can include similarity threshold(s) that guide how the clustering system determines how similar the probability distributions should be before merchants are associated with a particular cluster (or multiple clusters), which is explained in more detail below.

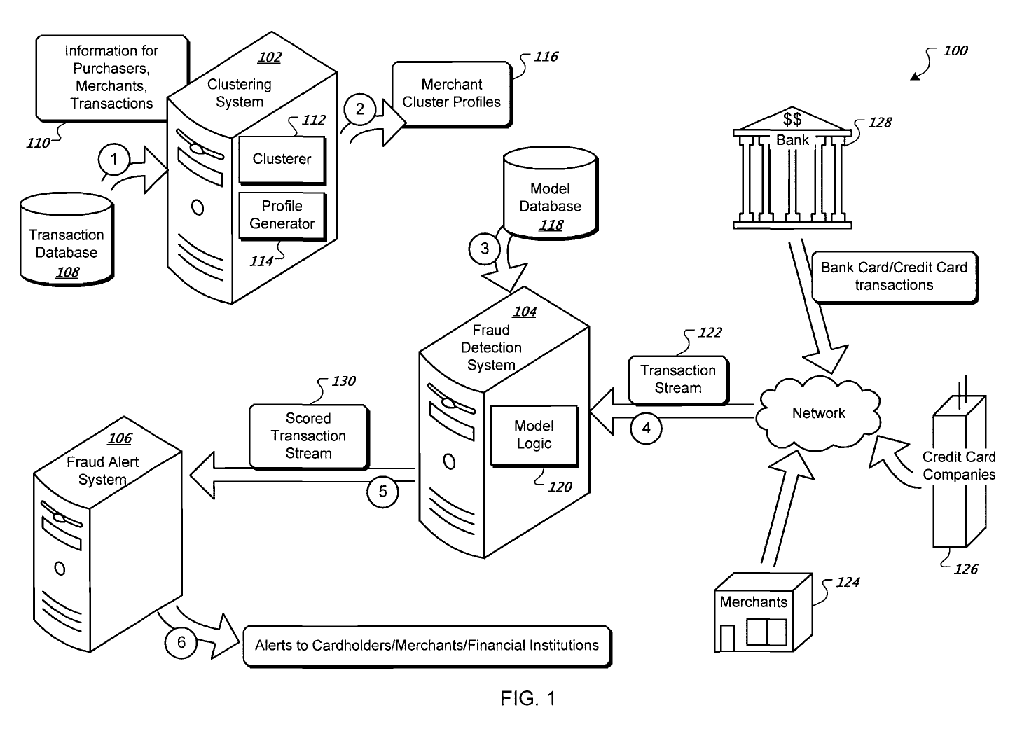

FIG. 1 is a diagram of an example system 100 for generating profile data associated with merchant clusters for use in detecting fraudulent transactions. The system 100 may include a clustering system 102 that clusters merchants based on transaction information for merchants and purchasers. The clustering system 102 may derive profile information for the merchant clusters and transmit the profile information for use by a fraud detection system 104, which in turn can use the information to score received transactions. A fraud alert system 108 can determine whether the transactions appear fraudulent based on the scored transaction. If the fraud alert system 108 determines that a transaction is likely fraudulent, the system 108 can alert concerned parties, such as the merchant involved in the transaction, a financial institution (e.g., credit card company) facilitating the transaction, or an owner of an account used to in the purchase (e.g., a debit or credit cardholder).

Numerically labeled arrows of FIG. 1 indicate an example sequence in which actions may occur within the system 100. However, the sequence not intended to be limiting but is given for illustrative purposes. Referring to an arrow labeled “1,” the clustering system 102 can access a transaction database 108. The transaction database 108 can store information 110 about previously recorded transactions (e.g., a corpus of transactions used to derive profile variables to train fraud detection models).

The information 110 can include purchaser identifiers (e.g., an identifier associated with an account involved in a transaction), merchant identifiers involved in transactions, spending amounts of the transactions, time/date stamps associated with the transactions, etc. Merchant identifiers and purchaser identifiers are also referred to herein as “merchants” and “purchasers” for simplicity of explanation.

The clustering system 102 can include a clusterer 112 that groups, or clusters, purchasers based on, for example, whether they made purchases from the same set of merchants with a similar frequency. The clusterer 112 also can cluster merchants. For example, the cluster 112 can group merchants based on probabilities that transactions associated with the merchants are associated with substantially similar purchaser clusters. This will be explained in greater detail in association with the following figures.

The clustering system 102 may include a profile generator 114. The profile generator 114 can derive profile variables associated with the merchant clusters for inclusion in merchant cluster profiles that describe typical activity associated with merchants that belong to particular merchant clusters. The merchant cluster profiles 116 may be transmitted by the clustering system 102 to a model database 118 as indicated by an arrow labeled “2.”

For example, a merchant cluster profile 116 can include variables associated with particular merchant clusters, where the variables indicate a typical amount of money spent per transaction, per time period, a typical number of transactions per time, etc.. In some implementations, the model database 118 can store other types of variables used to predict fraud such as variables associated with particular merchants, variables associated with particular purchasers, variables associated with particular purchaser clusters, etc.

The fraud detection system 104 can access the information stored in the model database 118 as indicated by an arrow labeled “3.” The fraud detection system 104 can train models using the information stored in the database 118, where the models are used to detect fraudulent transactions. For example, the models can be implemented using a neural network that applies optimization theory and statistical estimation to the variables in order to identify transactions that deviate from a norm associated with the particular kind, or type, of transaction analyzed by the fraud detection system 104.

The fraud detection system 104 can include model logic 120, which applies the model (e.g., trained neural network) to a transaction stream 122 that is received at the fraud detection system 104 as indicated by an arrow labeled “4.” In some implementations, the transaction stream 122 can include posts of completed transactions transmitted from merchants 124 involved in the transactions. In other implementations, the transaction stream 122 can include completed transactions associated with a financial institution that transferred payment as part of the transaction (e.g., credit card companies 128 and/or banks 128).

In yet other implementations, the transaction stream can include currently pending transactions. For example, before a credit card company 126 approves a payment to a particular merchant, the credit card company 126 may transmit the transaction to the fraud detection system 104. If the fraud detection system 104 determines that the transaction is likely fraudulent, the credit card company 126 can refuse to process payment for the transaction. If, on the other hand, the fraud detection system 104 determines that the transaction is likely valid, the fraud detection system 104 can transmit a message indicating that the credit card company 126 should process payment for that transaction.

The fraud detection system 104 can use the model logic 122 to score transactions, where the score may indicate a likelihood that the transaction is fraudulent (or valid). The fraud detection system 104 can transmit the scored transaction stream 130 to the fraud alert system 106 as indicated by and arrow labeled “5.”

In some implementations, the fraud alert system 106 can transmit alerts to one or more parties associated with a fraudulent transaction as indicated by an arrow labeled “6.” For example, the fraud alert system 106 may prompt an operator to call a bank cardholder associated with a transaction that is likely fraudulent. In another example, a fraud alert system can transmit a message to a merchant or credit card company indicating that a pending transaction is fraudulent and that the party should cancel or decline the transaction.

In another implementation, the fraud alert system can transmit information that indicates that a particular transaction is likely not fraudulent. For example, if a party to the transaction submits the transaction to the fraud detection system to determine whether to approve a payment or complete the transaction, the fraud alert system can transmit information back to the transmitting party indicating that the transaction should be processed because it is likely not fraudulent.

In yet other implementations, the scored transaction stream 130 can be forwarded to the transaction database 108 for use in updating the merchant cluster profiles or other variables associated with fraud, and consequently, the model used to identify fraudulent transactions.

Components of the system 100, such as the databases 108 and 118, the clustering system 102, the fraud detection system 104, and the fraud alert system are depicted in FIG. 1 as separate entities; however, these systems can be stored on a smaller or greater number of computing devices than depicted. For example, the systems and databases may be implemented on a single computer server or each of the systems can be implemented across several computer servers. Also, the example sequence of events is not intended to be limiting and can occur in a different order than the labeled arrows indicate. For example the transaction stream can be received at the same time the clustering system 102 is generating merchant cluster profiles 116.

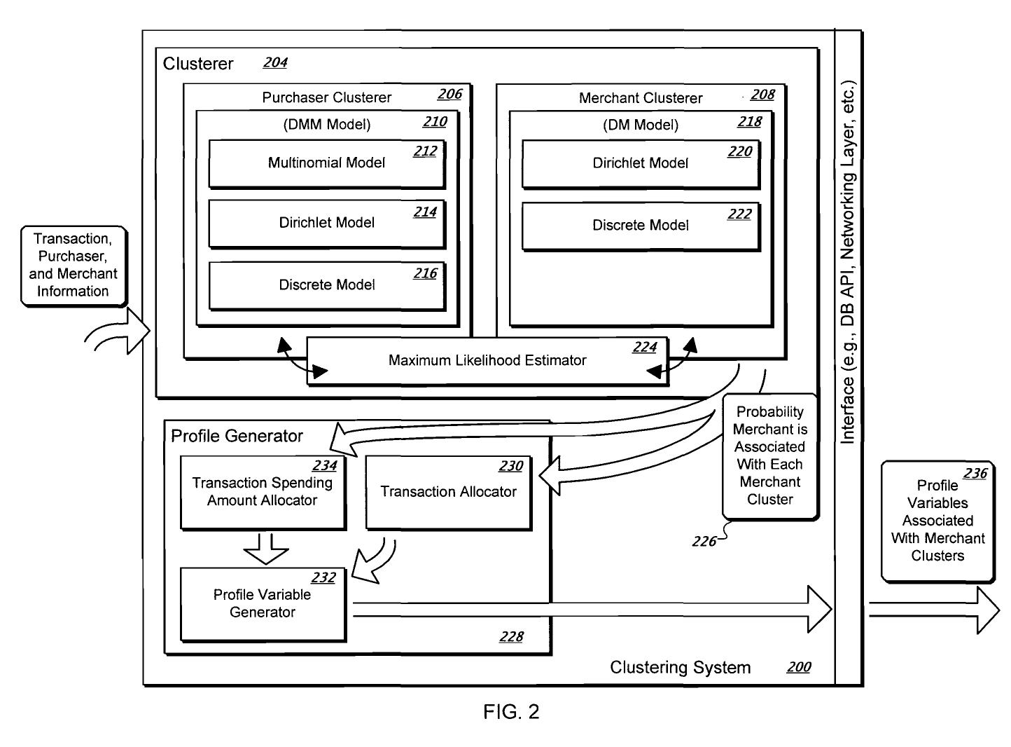

FIG. 2 is a diagram of an example clustering system 200 for grouping merchants to derive profile variables associated with the grouped merchants. In some implementations, the clustering system 200 clusters merchants into groups in which members of the group may vary little in their characteristics; however, variation between the merchant groups may be great. In some implementations, the clustering system 200 can—if the clusters are sufficiently large—generate a clustered data set that provides both statistical significance and information to build predictive models that generalize easily to new data.

In some implementations, the clustering system 200 can co-cluster categorical data as opposed to clustering continuous multivariate data; however, the same rational may apply to co-clustering as is applied to continuous clustering. Probabilistic, or “soft,” co-clustering may permit each entity (or observation) to have a probability of membership in each cluster. This may be appropriate when the clustering is an approximate model of a population so that some entities might belong to more than one cluster.

Before describing the elements of FIG. 2 in detail, several implementations of the clustering system 200 are given for illustrative purposes.

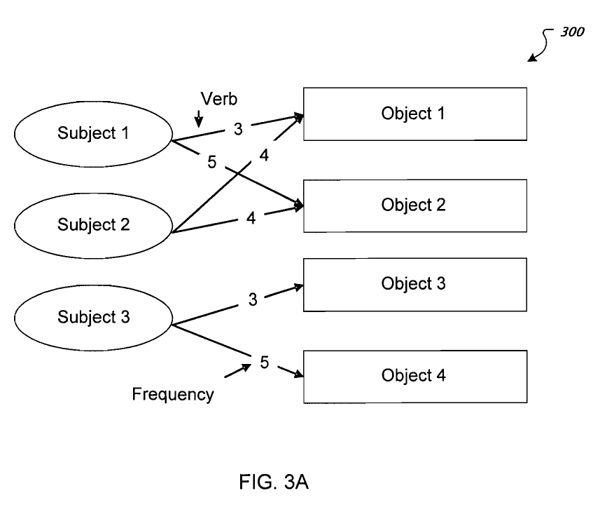

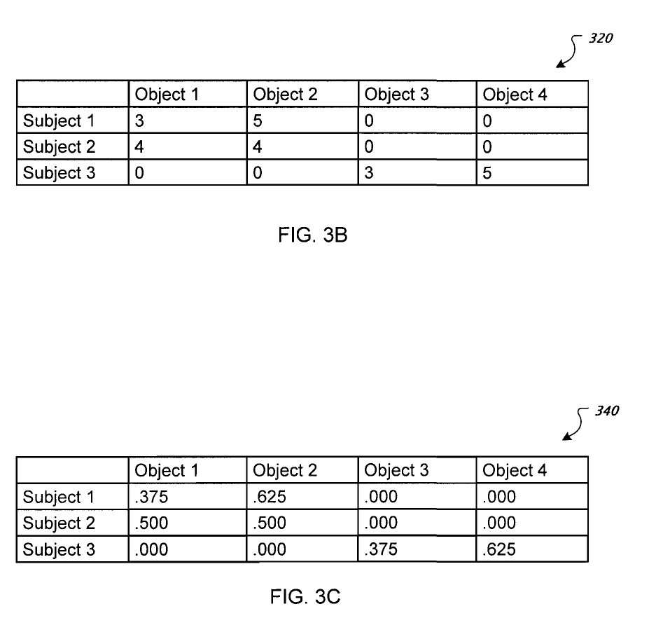

Referring to FIG. 3A, co-clustering can be described using a graph illustration. A graph is a collection of vertices and edges. The vertices, usually drawn as closed curves, can represent entities (e.g., people, business, abstractions, etc.) and the edges can represent relationships between entities. For example, in social networks the entities are people and the edges represent personal relationships between people. A minimum number of vertices necessary to traverse in order to travel from person “A” to person “B” can be called the degree of separation. In popular culture, it is sometimes claimed that there no more than six degrees of separation between any two people.

A bipartite graph can include two groups of entities—subjects and objects—in a graph, where every edge (also referred to as a “verb”) begins on a subject and ends on an object. If the subjects represent people, objects represent goods, and a relationship between them is “person purchases object.” The clustering system 200 can represent a purchasing history of a group of people by weighting on the edges to represent frequency of purchase. Similarly, if the subjects represent documents, the objects represent words, and the verb is “contains,” then the edges of the graph can represent a frequency of occurrence of a word within a document. For the next several paragraphs, the terms subject, verb, and object are used to describe the elements of a graph used in clustering.

FIG. 3A is an example subject-verb-object-frequency (SVOF) graph 300. The numbers, or frequencies, associated with the verbs can represent a number of times a subject-verb-object pattern appears. In the SVOF graph 300, subject 1 and subject 2 are similar in their relationships to object 1 and object 2, but subject 3 relates to different objects (e.g., objects 3 and 4).

FIG. 3B is an example table 320 that represents the SVOF graph 300 as an adjacency matrix. For example, the table 320 includes information that the subject 1 is linked to the object 1 three times, linked to object 2 five times, and linked to objects 3 and 4 zero times.

FIG. 3C is an example table 340 that states probabilities that each subject will be associated with each object. The subject 1 has a 0.375 probability that it will be associated with object 1 and a 0.625 probability that it will be associated with object 2. The subject 1 has zero probability of being associated with either object 3 or object 4. In this example, the probability may be determined by dividing the frequency a subject is associated with a particular object by a total number of associations for the subject. For example, the subject 1 has 8 associations (3 with object 1 and 5 with object 2). Thus, the probability that subject 1 is associated with object 1 is ⅗, or 0.375.

In some implementations, mathematically clustering subjects based on such probability vectors (e.g., probabilities in a row of a table like table 420) identifies similarities between subjects based on their relationships with objects. For example, the clustering system 200 may identify that subjects 1 and 2 have similar probability vectors, whereas subject 3 has a different probability vector than either subject 1 or subject 2.

If subject 1 and subject 2 are combined into a single cluster (or super vertex) and subject 3 is placed in its own cluster, then objects 1 and 2 can be identified as related based on their connection to the subject-1-subject-2 cluster; however, objects 3 and 4 seem only related to one another by their relationship to subject 3. Co-clustering can include a technique for computing these indirect relationships among subjects and indirect relationships among objects.

### An Overview of Example Soft Co-Clustering Models

In some implementations, soft co-clustering of subject and objects is accomplished in two phases using two different generative models. Phase I can use the frequency of objects associating with a given subject (e.g. the row data in Table 340 of FIG. 3C) to fit a three stage model based on a finite number of subject clusters. Phase II can use a probability that a single object choice came from each subject cluster to fit a two stage model based on a finite number of object clusters. The Phase I model provides a soft clustering of subjects into clusters (i.e., a membership of a subject in a subject cluster is given by a probability). The Phase II mode provides a soft clustering of objects.

### EXAMPLE PHASE I

### Subject Clustering

In some implementations, soft co-clustering is implemented using a generative model to create weights in the SVOF graph. The weights m on edges emanating from a subject “i” to all objects include integers chosen from a multinomial distribution with given probability p (where p is bolded to indicate it is a vector of values). The probability p, in turn, may be chosen according to a Dirichlet distribution that uses an intensity x. The intensity x may be chosen from a finite set of possible intensity vectors X according to a discrete distribution. A finite choice of C possible intensity vectors X can correspond to a membership of a subject in any of C subject clusters.

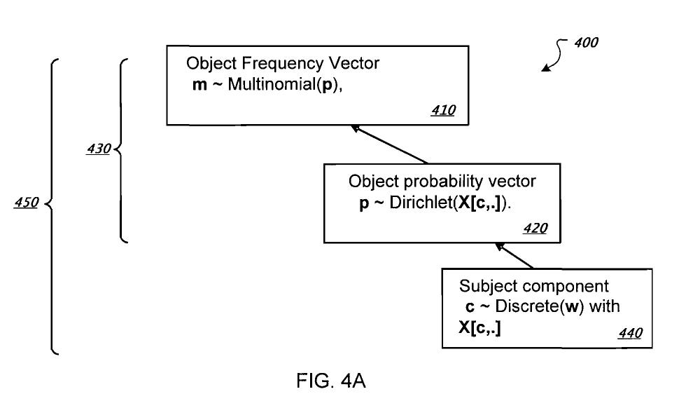

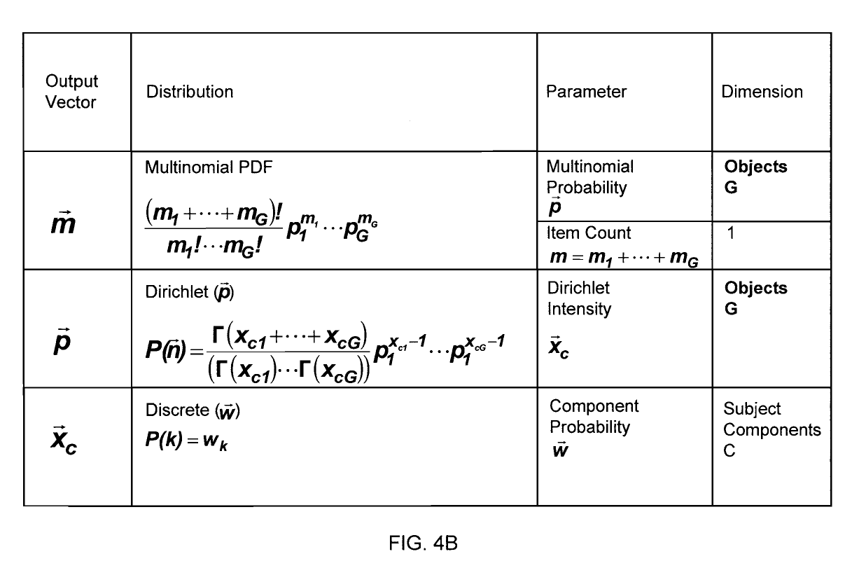

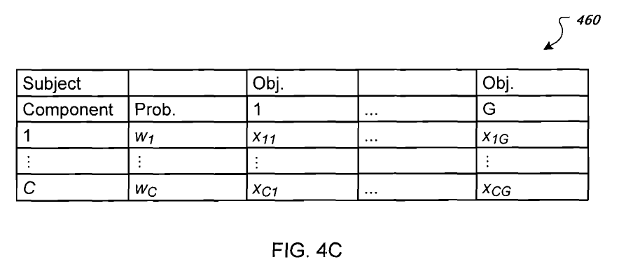

FIG. 4A is a diagram 400 that gives a bottom up illustration of this process. More specifically, FIG. 4A shows a generative model that relates all object choices for a single subject (e.g., calculates a probability of association between a single subject and all objects). In this example, the first layer is a multinomial model 410, and the second layer is a Dirichlet model 420 that parameterizes the multinomial model 410. Therefore, the first two layers constitute a Dirichlet Multinomial model 430. The third layer is a discrete model 440 that parameterizes the Dirichlet Multinomial model 430. In some implementations, the discrete model 440 chooses among a finite number (a mixture) of Dirichlet Multinomial models 430. Therefore, the entire model is called a Dirichlet Multinomial Mixture (DMM) model 450.

Latent variables in the DMM model 450 include an intensity matrix X and a probability vector \vec{w} according to some implementations. Rows of the intensity matrix X can correspond to subject clusters and columns can correspond to objects. The subject clusters may be randomly chosen according to a discrete distribution with a probability vector \vec{w}.

FIG. 4B gives a description of the random variables used in the DMM model 450. In some implementations, the output vectors m are observable and the various parameters are assumed latent. However, a number of subject clusters C are assumed, a likelihood maximization can be used to estimate the parameters of the DMM model 450. The result of the estimation can include a set of parameters in a table 460 as shown in FIG. 4C, where each row represents a subject cluster and each column represents an object. A maximization likelihood technique used in the estimation, or fit, of the table of 460 is subsequently described in association with a maximization likelihood estimator included in the cluster system 200 of FIG. 2.

### An Example Subject Clustering Formula from the DMM

In some implementations, the clustering on subjects provided by the DMM model 450 is soft in the sense that a membership of a subject “i” in a subject cluster “c” is a probability. For example, for a given subject “i” the probability that it came from cluster “c” is dependent on the weights/frequencies m on the outgoing edges of subject “i,” where the weights/frequencies can be alternatively expressed using values in the subject's row in a table like the table 320 of FIG. 3B. In one implementation, the formula for this dependence is

$$p ( subject\_component = c \vert {\vec{m}}_{i} ) = \frac{p ( {\vec{m}}_{i} \& subject\_component = c )}{p ( {\vec{m}}_{i} )}$$

Given a fit DMM model as described in table 4C, the probability given in the above equation can be exactly computable. In fact there is a probability vector describing the membership of subject “i” in each of the subject clusters, according to some implementations. This probability vector describing the membership may be used in the “soft,” or probabilistic, co-clustering of subjects.

### EXAMPLE PHASE II

### Object Clustering

Although the example phase I DMM model alone does not cluster objects, it can provide a kind of data source for clustering them. For example, a probability that a single object “j” was chosen from a subject cluster “c,” is given by p(component=c|\vec{e}ⱼ) where \vec{e}ⱼ is zero in all coordinates except the j-th coordinate where it is 1. So, the DMM model can give a probability vector that an object was chosen from each subject cluster. The example phase II generative model clusters objects may be based on this subject cluster probability vector p.

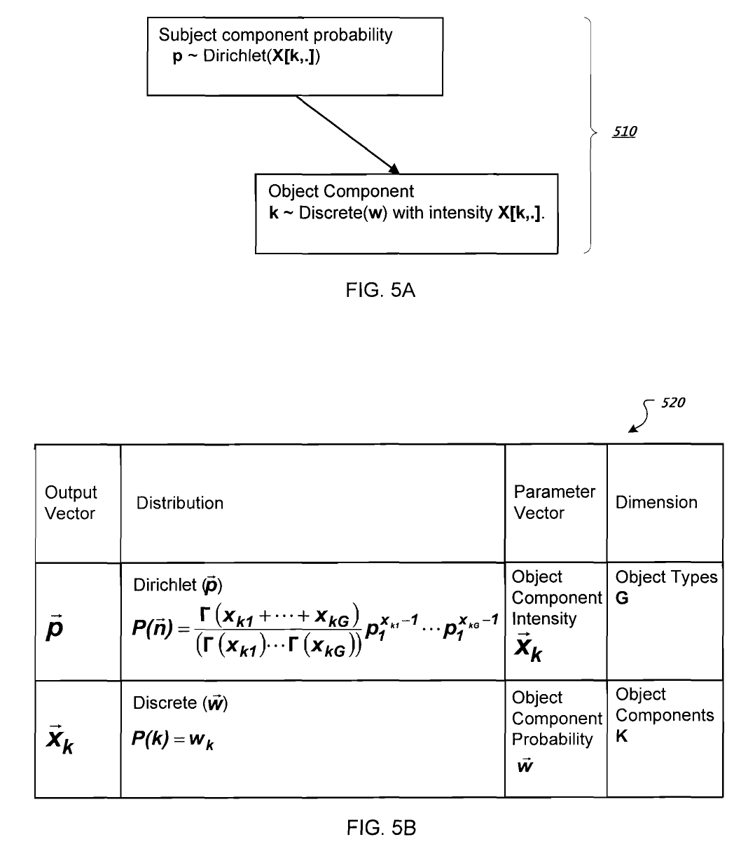

In one implementation, the example phase II model is a two stage Dirichlet Mixture (DM) Model that chooses probability vectors p based on a distinct intensity vector X[k,.], which is a row from an intensity matrix X. This row choice is made according to a discrete object cluster probability vector w. FIG. 5A illustrates the two stages of the example phase II DM model 510. Table 520 shows example formulas involved in the DM model 510.

For each object “i,” the example Phase II DM model 510 provides a probability that object “i” belongs to an object cluster “c.”

$$p ( object\_component = k \vert {\vec{p}}_{i} ) = \frac{p ( {\vec{p}}_{i} \& object\_component = k )}{p ( {\vec{p}}_{i} )}$$

Object “i” can be completely characterized by probability vector \vec{p}ᵢ just as subject “i” can be characterized by the frequency vector \vec{m}ᵢ in the example phase I DMM 450. This demonstrates that for any object “i,” the phase II DM model 510 can provide a soft clustering.

Referring to FIG. 2, in some implementations, the clustering system 200 can implement the soft co-clustering as described above. In some implementations, the clustering system 200 can include a clusterer 204 that clusters data sets. The clusterer 204 can include a purchaser clusterer 206 for generating clusters of purchasers and a merchant clusterer 208 for generating clusters of merchants.

As previously described, the purchaser clusterer 206 can include a three-stage DMM model 210 to cluster purchasers. For example, the DMM model 210 can include a multinomial model 212, a Dirichlet model 214, and a discrete model 216, where the output of one model may be used to parameterize a second model. Similarly and as previously described, the merchant clusterer 208 can include a DM model 218 used to cluster the merchants. The DM model 218 can include a Dirichlet model 220 and a discrete model 222 such as the models described in FIGS. 5A and 5B.

The clusterer 204 also can include a maximum likelihood estimator 224 to estimate parameters of a DMM model such as the DMM model described in FIGS. 4A and 4B. An example of the result of such estimation was previously described in association with the table 460 FIG. 4C.

In some implementations the maximum likelihood estimator 224 can estimate parameters of the DMM model using a cross the entropy (CE) method. In the following general description, the CE method is implemented as a Monte Carlo technique. For example, the CE method can place a prior distribution on all parameters to be estimated. One choice for a vector parameter is \vec{x}˜N(\vec{μ},σI)., a multivariate normal distribution with a diagonal covariance matrix. The mean and the standard deviation of this distribution are variable but bounded. The chosen parameter vectors may dictate a negative log likelihood contribution, θ(\vec{m}ⱼ;\vec{x}ᵢ), for each simulated parameter \vec{x}ᵢ, and each data record \vec{m}ⱼ.

In one implementation, the maximum likelihood estimator (MLE) 224 can implement a CE maximum likelihood estimation algorithm as follows. First, for each parameter, the MLE can select several xᵢ˜N(μᵢ,σᵢ). Second, for all parameter guesses \vec{x}ᵢ, the MLE can choose q exemplars that have the smallest negative log likelihoods

$${\sum }_{i , j} θ ( {\vec{m}}_{j} ; {\vec{x}}_{i} ) .$$

These exemplars may be referred to as the elite set of parameter guesses.

Third, the MLE can compute the mean and the standard deviations for the elite set. On convergence, the MLE can end the algorithm. Otherwise the MLE can return to the second step. In this way, the MLE can fit the phase I DMM model and the phase II DM model. The clusterer 204 can then output information 226 for each merchant that is indicative of probabilities that a particular merchant is associated with each merchant cluster (i.e., merchant cluster membership probabilities).

In some implementations, the cluster 204 may store the information 226 in a database (not shown) as a matrix of probabilities. A profile generator 228 included in the clustering system 200 can access the output information 226 for use in generating profile variables associated with merchant clusters. For example, each transaction in the data set may be divided by a transaction allocator 230 into merchant clusters according to the probability that the merchant belongs in each cluster.

A profile variable generator 232 can compute profile variables for each cluster, and those variables along with other variables may be used to train models that predict, for example, bank card fraud. Additionally, for each merchant in a transaction, the amount may be divided by a transaction spending amount allocator 234 according to cluster probability membership. The profile variable generator 232 may then compute profile variables as mentioned above. The cluster profile variables 236 and other variables (not shown) can be used as inputs to a model which predicts the likelihood of fraud.

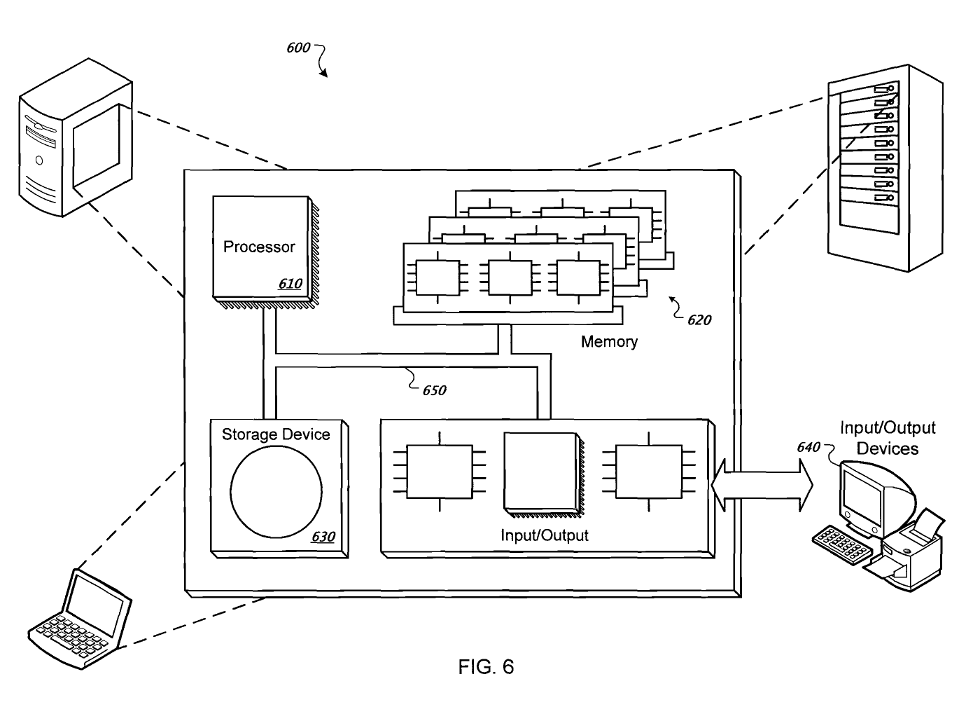

FIG. 6 is a schematic diagram of a computer system 600. The system 600 can be used for the operations described in association with any of the computer-implement methods described previously, according to one implementation. The system 600 is intended to include various forms of digital computers, such as laptops, desktops, workstations, personal digital assistants, servers, blade servers, mainframes, and other appropriate computers. The system 600 can also include mobile devices, such as personal digital assistants, cellular telephones, smartphones, and other similar computing devices. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The system 600 includes a processor 610, a memory 620, a storage device 630, and an input/output device 640. Each of the components 610, 620, 630, and 640 are interconnected using a system bus 650. The processor 610 is capable of processing instructions for execution within the system 600. The processor may be designed using any of a number of architectures. For example, the processor 610 may be a CISC (Complex Instruction Set Computers) processor, a RISC (Reduced Instruction Set Computer) processor, or a MISC (Minimal Instruction Set Computer) processor.

In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 may be a floppy disk device, a hard disk device, an optical disk device, or a tape device.

The input/output device 640 provides input/output operations for the system 600. In one implementation, the input/output device 640 includes a keyboard and/or pointing device. In another implementation, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

The computer system can include clients and servers. A client and server are generally remote from each other and typically interact through a network, such as the described one. The relationship of client and server arises by virtue of computer programs running on the respective computers and having a client-server relationship to each other.

Although a few implementations have been described in detail above, other modifications are possible. For example, the clustering is not limited to clustering merchants or purchasers. In other implementations, the clustering system can be used to perform machine language learning. For example, association grounded semantics (AGS) is a theory of assigning meaning (semantics) to natural language based on the association of each word with all other words. AGS theory holds that each word in a natural language derives its meaning from the words with which it occurs. Thus, a model of word co-occurrence is a model of the meaning of a word. Two words which have the same co-occurrence statistics with other words must have the same meaning because they are substitutable.

In some implementations, soft co-clustering as previously described may permit an understanding of a language without rules composed by an expert. Instead, a grammar can be created from a statistical model, which may—in some implementations—be self improving, robust with respect to inconsistencies in training, and hold some promise of becoming complete.

For example, in a language learning implementation, the subjects can be documents, the verb can be “contains,” and the objects can be words. The interpretation of soft co-clustering would be a clustering of documents according to terminology and a clustering of words according to the context of their occurrence.

In yet other implementations, information other than spending amount or number of transaction can be associated with the merchant clusters. For example, spending frequency and amount statistics can be divided based on fraud or non-fraud categorizations as well as by merchant cluster.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-implemented method comprising:
accessing a data structure that includes information about purchasers, merchants, and financial transactions between the purchasers and the merchants;
generating purchaser clusters comprising clustering the purchasers based on which purchasers make purchases from the same or similar merchants, wherein each purchaser cluster adopts associations between purchasers belonging to the purchase cluster and merchants from which these purchasers have made purchases;
generating merchant clusters comprising clustering merchants based on which merchants are associated with the same or similar purchase clusters; and
outputting profile information that characterizes typical purchases associated with one or more of the merchant clusters for use in detecting fraudulent transactions.

2. The method of claim 1, wherein generating the purchaser clusters further comprises using a frequency of occurrence of purchases by the purchasers from the merchants to fit a model based on a finite number of purchase clusters.

3. The method of claim 2, wherein the model comprises a subject-verb-object-frequency (SVOF) graph, wherein subject nodes represent the purchasers, verb edges represent a frequency of financial transactions between the purchasers and the merchants, and object nodes represent the merchants.

4. The method of claim 3, further comprising generating weights w for the verb edges emanating from a subject node i to object nodes, wherein the weights m comprise integers selected from a multinomial distribution with a given probability p.

5. The method of claim 4, further comprising selecting the given probability p based on a Dirichlet distribution with an intensity vector x.

6. The method of claim 5, further comprising selecting the intensity vector x from C possible intensity vectors according to a discrete distribution.

7. The method of claim 6, further comprising generating the C possible intensity vectors based on a probability a membership of a purchaser in each of C purchase clusters.

8. The method of claim 2, wherein fitting the model comprises using a maximization estimation comprising selecting multiple xᵢ˜N(μᵢ,σᵢ) for each parameter to be estimated, for all parameter guesses \vec{x}ᵢ selecting q exemplars that have a smallest negative log likelihood
$${\sum }_{i , j} θ ( {\vec{m}}_{j} ; {\vec{x}}_{i} ) ,$$
and calculating a mean and a standard deviation for the q exemplars until convergence.

9. The method of claim 1, wherein calculating the merchant clusters further comprises generating, for each merchant, a probability vector p that the merchant is associated with each of the purchase clusters and clustering the merchants based on similarities in probability vectors.

10. The method of claim 9, further comprising selecting the probability vector p based on a Dirichlet distribution with an intensity vector X[k,.], which is a row from an intensity matrix X.

11. The method of claim 10, further comprising selecting the row from the intensity matrix X based on a discrete object cluster probability vector w.

12. The method of claim 9, further comprising allocating a spending amount of each transaction among the merchant clusters based on the probability vector p.

13. The method of claim 12, further comprising determining one or more spending time averages for spending amounts allocated to each merchant cluster.

14. The method of claim 13, wherein determining a spending time average comprises, at a time t, allocating an amount of a current purchase to each merchant cluster according to p, weighting the amount of the current purchase with a previous time average so that recent spending counts more heavily than past spending.

15. The method of claim 13, further comprising deriving spending time variables from the one or more spending time averages.

16. The method of claim 15, wherein the profile information for a merchant cluster comprises the spending time variables used to identify deviations from a norm in spending behavior associated with the merchant cluster.

17. The method of claim 1, wherein a purchaser comprises a debit or credit cardholder and a financial transaction comprises transaction posts from a merchant associated with the financial transaction.

18. The method of claim 1, wherein clustering the merchants results in one or more of the merchants being included in more than one of the merchant clusters.

19. The method of claim 1, wherein clustering the purchasers results in one or more of the purchasers being included in more than one of the purchase clusters.

20. The method of claim 1, further comprising allocating a spending amount of each transaction among the merchant clusters based on a probability that a merchant associated with the transaction belongs in a merchant cluster.

21. A computer program product tangibly embodied in a computer storage device, the computer program product including instructions that, when executed, perform operations comprising:
accessing a data structure that includes information about purchasers, merchants, and financial transactions between the purchasers and the merchants;
generating purchaser clusters comprising clustering the purchasers based on which purchasers make purchases from the same or similar merchants, wherein each purchaser cluster adopts associations between purchasers belonging to the purchase cluster and merchants from which these purchasers have made purchases;
generating merchant clusters comprising clustering merchants based on which merchants are associated with the same or similar purchase clusters; and
outputting profile information that characterizes typical purchases associated with one or more of the merchant clusters for use in detecting fraudulent transactions.

22. A system comprising:
a data structure that includes information about purchasers, merchants, and financial transactions between the purchasers and the merchants;
a purchaser clusterer to generate purchaser clusters comprising clustering the purchasers based on which purchasers make purchases from the same or similar merchants, wherein each purchaser cluster adopts associations between purchasers belonging to the purchase cluster and merchants from which these purchasers have made purchases;
a merchant clusterer to generate merchant clusters comprising clustering merchants based on which merchants are associated with the same or similar purchase clusters; and
an interface to output profile information that characterizes typical purchases associated with one or more of the merchant clusters for use in detecting fraudulent transactions.
